(19) United States
(12) Patent Application Publication
(10) Pub. No.: US 2011/0156515 A1
(43) Pub. Date: Jun. 30, 2011

(54) STRUCTURE OF WATER-PROOF MOTOR FOR ROTATING AXLE OF ROASTING STOVE

(76) Inventor: Kao Hsung Tsung, Taipei City (TW)

(21) Appl. No.: 12/649,369

(22) Filed: Dec. 30, 2009

(51) Int. Cl. H02K 5/10; A47J 37/04

(52) U.S. Cl. 310/88; 99/421 H

(57) ABSTRACT

A structure of waterproof motor for an electric rotating axle of a roasting stove is disclosed, the motor can be installed on the roasting stove to allow rotation of the electric rotating axle for operating the roasting stove, the waterproof motor includes a housing composed of an upper cover and a lower lid, inside the housing there is a receiving space in which a fixing seat is provided on the lower lid; the fixing seat is provided thereon with a waterproof sleeve and a driving member which has a dynamic axle, the dynamic axle is extended through the waterproof sleeve to link with the electric rotating axle to rotate it; the structure is endued with an effect of avoiding invading of water vapor against the motor.

### BACKGROUND OF THE INVENTION

1. Field of the Invention

The present invention relates to a structure used on an electric rotating axle of a roasting stove, and especially to a structure of waterproof motor for driving the electric rotating axle of the roasting stove.

2. Description of the Prior Art

In our modern lives, roasting stoves are necessary utensils for people to deal with outdoor leisure or gatherings, for the purpose of increasing interest of roasting, outdoor roasting generally is to roast bigger foods, such as roasting a whole turkey, a whole suckling pig and a big cube of beef and pork etc. such as is shown in FIG. 1; such a stove structure used to roast bigger foods normally includes a roasting stove 90, an electric rotating axle 91 provided above the roasting stove 90 and a motor unit 92 used to rotate the electric rotating axle 91.

Wherein: the electric rotating axle 91 can be serially inserted thereon with bigger foods to be roasted on the roasting stove 90, and the motor unit 92 can be used to rotate the electric rotating axle 91. When the motor unit 92 drives the electric rotating axle 91 to rotate sustainingly and slowly, fire in the roasting stove 90 can roast foods uniformly with an appropriate temperature, and the foods can be well roasted without having the situation that part of them are burnt and part not well roasted.

The roasting stove 90 has the above stated advantages, it has also a quite serious defect though, namely: the motor unit 92 has no function of water proofing, hence the roasting stove 90 only is suitable for use indoors or in sunny weather with mild wind; while in a raining or cloudy day or night with heavy dews, each time after roasting, the motor unit 92 must be detached to be stored in a room, or must be covered thereover with a water or rain proofing rain coat, to avoid the motor unit 92 to be damaged after being showered with rain or getting wetted and thereby to make short circuit or even to hurt consumers.

In view of the above stated, the inventor of the present invention provides a structure of waterproof motor for the electric rotating axle of a roasting stove based on his studying in related field and experience of years, the motor can get rid of the problems of the conventional motor unit, the problems are: the motor unit has no function of water and rain proofing, and is subjected to being damaged after being showered with rain or getting wetted; the waterproof motor of the present invention thus can achieve objects of being convenient for use and able to avoid to be subjected to being damaged after getting wetted.

### SUMMARY OF THE INVENTION

The object of the present invention is to provide a structure of waterproof motor for the electric rotating axle of a roasting stove, the motor can be used in a wet environment or weather for driving to rotate the electric rotating axle of the roasting stove for roasting foods without the problem of having the motor damaged.

In order to achieve the above object, the structure of waterproof motor for the electric rotating axle of a roasting stove of the present invention can be installed on the roasting stove to allow rotation of the electric rotating axle for operating the roasting stove, the structure of waterproof motor includes a housing composed of an upper cover and a lower lid, inside the housing there is a receiving space in which a fixing seat is provided on the lower lid; the fixing seat is provided thereon with a waterproof sleeve and a driving member which has a dynamic axle, the dynamic axle is extended through the waterproof sleeve to link with the electric rotating axle to rotate it.

Wherein: the housing is provided thereon with a hole for extending of an electric power line therein to connect the hole of the driving member, a sealing sleeve for sealing the hole is provided between the electric power line and the hole; and more, the housing is provided thereon with a control switch for controlling the driving member and a switch receiving cavity for receiving the control switch; wherein the control switch is a waterproof switch, and the control switch is sealed in the switch receiving cavity.

The above mentioned lower lid has an axle hole for extending of the waterproof sleeve out of it, so that the dynamic axle can be extended through the waterproof sleeve to connect the electric rotating axle of the roasting stove; moreover, a waterproof sealing piece is tightly pressed between the fixing seat and the lower lid, when the upper cover and the lower lid get close to connected with each other, the upper cover can tightly press against the lower lid to achieve the object of preventing invading of evaporated water against the driving member.

Operation in practice of the above elements is described in details as below:

Wherein: for the purpose of reducing the working hours in assembling and increasing the tightness of connecting of components after assembling, and for the purpose of achieving the object of water proofing, in practicing, the above mentioned upper cover can be provided on its top surface with a recess having on its bottom first screw holes; and in practicing, the fixing seat can include a bottom plate, two lateral sides of the bottom plate are provided each with an upright fixing portion parallel to each other, the two fixing portions have therebetween an appropriate gap for providing of the above mentioned sleeve on the bottom plate; each fixing portion is in a shape of inversed “L”, and is provided at a position in corresponding to that of a corresponding first screw hole with a second screw hole; the first and second screw holes are provided for locking therein bolts to make fixedly connecting of the upper cover with the fixing seat.

And more, when in practicing, the bottom plate of the fixing seat can be connected by welding onto the lower lid, while the sealing piece is cut to have a notch centrally, in order that the bottom plate can be connected by welding onto the lower lid. And for the purpose of obtaining a better waterproofing effect, the bottom plate can be used to cover the notch and the areas of the sealing piece around the notch.

Additionally, when in practicing, the above mentioned recess on the top surface of the upper cover can be provided thereon with a waterproofing sticker for sealing the first screw holes, in order to increase the waterproofing effect, and the waterproofing sticker can be provided on its surface with marks for advertising, recognition etc.

Moreover, when in practicing, the above mentioned driving member includes electromagnetic elements such as a set of stator and a set of rotor etc., in order to reach an object of rotating, the driving member can further include two fixing lugs having thereon a fixing hole each, and the fixing portions of the fixing seat are provided at positions in corresponding to those of the fixing holes with mounting holes, screws can be extended into the fixing holes and the mounting holes for locking and connecting of the driving member to/with the fixing seat.

Additionally, for the purpose of conveniently mounting the motor on the roasting stove, the lower lid can be provided thereon with a hanging hole for hanging it on the roasting stove; in practicing, so long that the roasting stove is provided on its wall with a support having a hanging hook for hanging the hanging hole on it, and the above mentioned dynamic axle is connected with the electric rotating axle of the roasting stove, assembling of the motor thus is completed.

As compared with the conventional technique, the structure of waterproof motor for the electric rotating axle of a roasting stove of the present invention can avoid invading of evaporated water against the electric components of it, hence it works in a wet environment or weather to rotate the electric rotating axle of the roasting stove for roasting foods without the problem of having the motor damaged.

The present invention will be apparent after reading the detailed description of the preferred embodiment thereof in reference to the accompanying drawings.

### BRIEF DESCRIPTION OF THE DRAWINGS

FIG. 1 is a perspective view showing a conventional motor installed on a roasting stove;

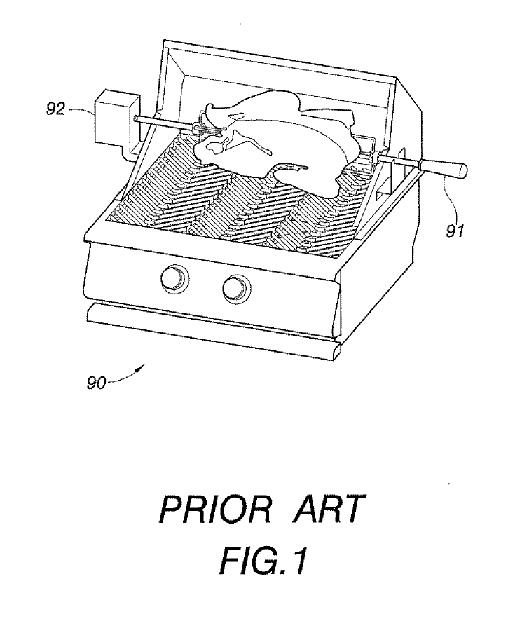

FIG. 2 is a perspective view showing the present invention on a roasting stove;

FIG. 3 is a perspective view showing the appearance of the present invention;

FIG. 4 is an anatomic perspective view of the present invention;

FIG. 5 is a sectional view of the present invention.

### DETAILED DESCRIPTION OF THE PREFERRED EMBODIMENT

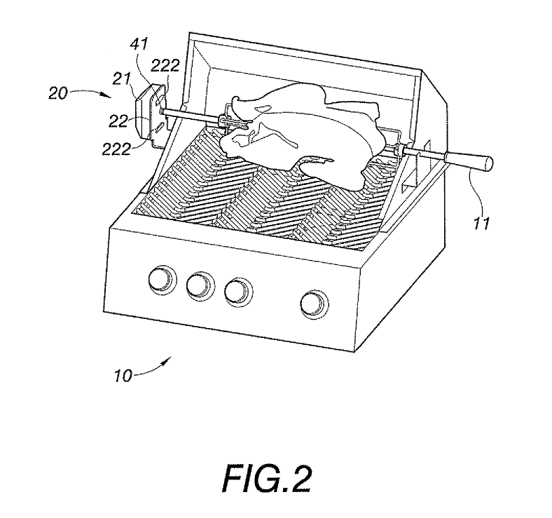

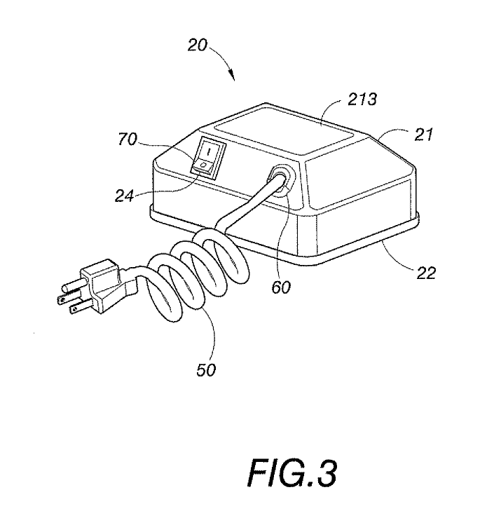

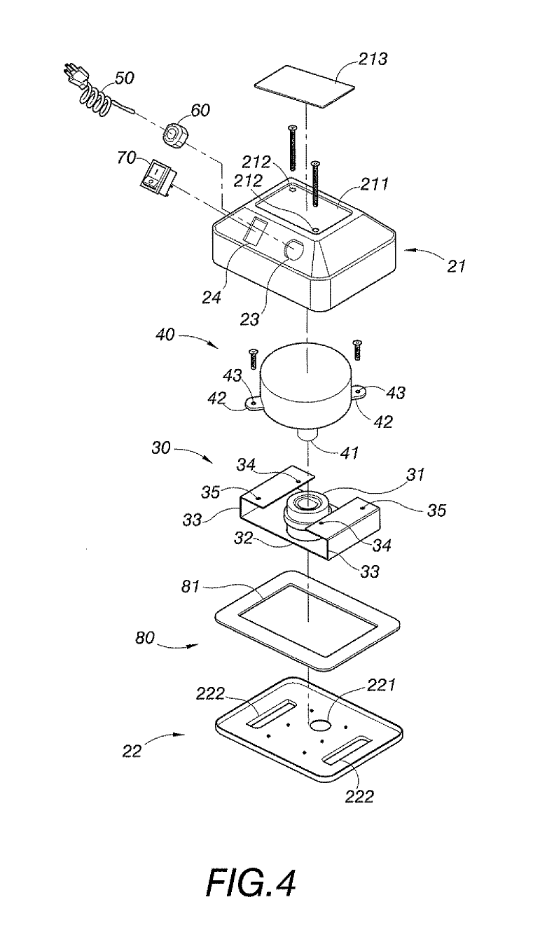

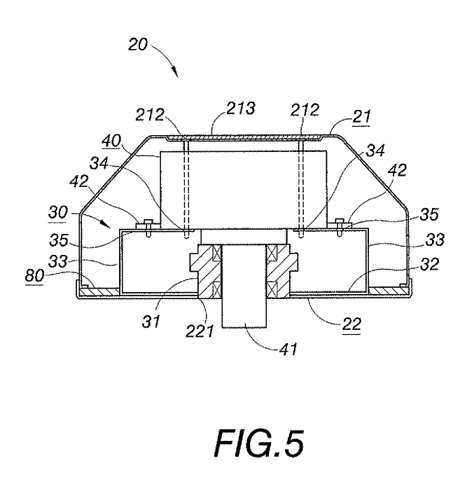

As shown in FIGS. 2 to 4, the structure of waterproof motor for an electric rotating axle 11 of a roasting stove 10 of the present invention can be installed on the roasting stove 10 to allow rotation of the electric rotating axle 11 for operating the roasting stove 10, the structure of waterproof motor includes a housing 20 composed of an upper cover 21 and a lower lid 22, inside the housing 20 there is a receiving space in which a fixing seat 30 is provided on the lower lid 22; the fixing seat 30 is provided thereon with a waterproof sleeve 31 and a driving member 40 which has a dynamic axle 41, the dynamic axle 41 is extended through the waterproof sleeve 31 to link with the electric rotating axle 11 to rotate it.

Wherein: as shown in FIGS. 2, 4 and 5, the housing 20 is provided thereon with a hole 23 for extending of an electric power line 50 therein to connect the hole 23 of the driving member 40, a sealing sleeve 60 for sealing the hole 23 is provided between the electric power line 50 and the hole 23; and more, the housing 20 is provided thereon with a control switch 70 for controlling the driving member 40 and a switch receiving cavity 24 for receiving the control switch 70; wherein the control switch 70 is a waterproof switch, and the control switch 70 is sealed in the switch receiving cavity 24.

The above mentioned lower lid 22 has an axle hole 221 for extending of the waterproof sleeve 31 out of it, so that the dynamic axle 41 can be extended through the waterproof sleeve 31 to connect the electric rotating axle 11 of the roasting stove; moreover, a waterproof sealing piece 80 is tightly pressed between the fixing seat 30 and the lower lid 22, when the upper cover 21 and the lower lid 22 get close to connected with each other, the upper cover 21 can tightly press against the lower lid 22 to achieve the object of preventing invading of evaporated water against the driving member 40.

Operation in practice of the above elements is described in details as below:

Wherein: for the purpose of reducing the working hours in assembling and increasing the tightness of connecting of components after assembling, and for the purpose of achieving the object of water proofing, in practicing, the above mentioned upper cover 21 can be provided on its top surface with a recess 211 having on its bottom first screw holes 212; and in practicing, the fixing seat 30 can include a bottom plate 32, two lateral sides of the bottom plate 32 are provided each with an upright fixing portion 33 parallel to each other, the two fixing portions 33 have therebetween an appropriate gap for providing of the waterproof sleeve 31 on the bottom plate 32; each fixing portion 33 is in a shape of inversed “L”, and is provided at a position in corresponding to that of a corresponding first screw hole 212 with a second screw hole 34; the first and second screw holes 212, 34 are provided for locking therein bolts to make fixedly connecting of the upper cover 21 with the fixing seat 30.

Additionally, when in practicing, the above mentioned recess 211 on the top surface of the upper cover 21 can be provided thereon with a waterproofing sticker 213 for sealing the first screw holes 212, in order to increase the waterproofing effect, and the waterproofing sticker can be provided on its surface with marks for advertising, recognition etc.

And when in practicing, the bottom plate 32 of the fixing seat 30 can be connected by welding onto the lower lid 22, while the sealing piece 80 is cut to have a notch 81 centrally, in order that the bottom plate 32 can be connected by welding onto the lower lid 22. And for the purpose of obtaining a better waterproofing effect, the bottom plate 32 can be used to cover the notch 81 and the areas of the sealing piece 80 around the notch 81.

Moreover, when in practicing, the above mentioned driving member 40 includes electromagnetic elements such as a set of stator and a set of rotor etc., in order to reach an object of rotating, the driving member 40 can further include two fixing lugs 42 having thereon a fixing hole 43 each, and the fixing portions 33 of the fixing seat 30 are provided at positions in corresponding to those of the fixing holes 43 with mounting holes 35, bolts can thus be extended into the fixing holes 43 and the mounting holes 35 for locking and connecting the driving member 40 to/with the fixing seat 30.

Additionally, for the purpose of conveniently mounting the motor on the roasting stove, the lower lid 22 can be provided with a hanging hole 222 for hanging it on the roasting stove; practicing, so long that the roasting stove is provided on its wall with a support having a hanging hook for hanging the hanging hole 222 on it, and the above mentioned dynamic axle 41 is connected with the electric rotating axle 11 of the roasting stove, assembling of the motor thus is completed.

The names of components of the invention provided above and the drawings are only for illustrating the preferred embodiment of the present invention, and not for giving any limitation to the scope of the present invention. It will be apparent to those skilled in this art that various equivalent modifications or changes without departing from the spirit, scope and characteristic of this invention shall fall within the scope of the appended claims.

1. A structure of waterproof motor for an electric rotating axle of a roasting stove, said waterproof motor includes a housing composed of an upper cover and a lower lid, inside said housing there is a receiving space in which a fixing seat is provided on said lower lid; said fixing seat is provided thereon with a waterproof sleeve and a driving member which has a dynamic axle, said dynamic axle is extended through said waterproof sleeve to link with said electric rotating axle to rotate said electric rotating axle; wherein:
said housing is provided thereon with a hole for extending of an electric power line therein to connect said hole of said driving member, a sealing sleeve for sealing said hole is provided between said electric power line and said hole;
and more, said housing is provided thereon with a control switch for controlling said driving member and a switch receiving cavity for receiving said control switch; wherein said control switch is a waterproof switch, and said control switch is sealed in said switch receiving cavity;
said lower lid has an axle hole for extending of said waterproof sleeve out of it, in order that said dynamic axle is extended through said waterproof sleeve to connect said electric rotating axle of said roasting stove;
moreover, a waterproof sealing piece is tightly pressed between said fixing seat and said lower lid, when said upper cover and said lower lid get close to connected with each other, said upper cover tightly presses against said lower lid.

2. The structure of waterproof motor for an electric rotating axle of a roasting stove as in claim 1, wherein said upper cover is provided on its top surface with a recess having on its bottom first screw holes; said fixing seat includes a bottom plate, two lateral sides of said bottom plate are provided each with an upright fixing portion parallel to each other, each of said fixing portions is provided at a position in corresponding to that of a corresponding first screw hole with a second screw hole; said first and second screw holes are provided for locking therein bolts to make fixedly connecting of said upper cover with said fixing seat.

3. The structure of waterproof motor for an electric rotating axle of a roasting stove as in claim 2, wherein said driving member further includes two fixing lugs having thereon a fixing hole each, and said fixing portions of said fixing seat are provided at positions in corresponding to said fixing holes with mounting holes, screws are extended into said fixing holes and said mounting holes for locking and connecting of said driving member to/with said fixing seat.

4. The structure of waterproof motor for an electric rotating axle of a roasting stove as in claim 2, wherein said recess is provided thereon with a waterproofing sticker for sealing said first screw holes.

5. The structure of waterproof motor for an electric rotating axle of a roasting stove as in claim 4, wherein said waterproofing sticker is provided on its surface with marks for advertising, recognition etc.

6. The structure of waterproof motor for an electric rotating axle of a roasting stove as in claim 1, wherein said lower lid is provided thereon with a hanging hole.

7. The structure of waterproof motor for an electric rotating axle of a roasting stove as in claim 1, wherein said bottom plate of said fixing seat is connected by welding onto said lower lid, while said sealing piece is cut to have a notch centrally, in order that said bottom plate is connected by welding onto said lower lid.
